(19) United States
(12) Patent Application Publication
(10) Pub. No.: US 2008/0199833 A1
(43) Pub. Date: Aug. 21, 2008

(54) Automatic intuitive painting methodology

(76) Inventor: Andrew Maishman, Blairstown, NJ (US)

Correspondence Address: Kenneth P. Glynn, 24 Mine Street, Flemington, NJ, 08822, US

(21) Appl. No.: 11/706,626

(22) Filed: Feb. 15, 2007

(51) Int. Cl. G09B 11/10

(52) U.S. Cl. 434/84

(57) ABSTRACT

An automatic intuitive painting methodology that involves the use of the non-dominant hand, forearm, elbow, palm and knuckles to move paint on a canvas or other substrate, coupled with various rotational and tilting techniques while the paint is still flowable to create a single or multiple substrate work of art. Interpretation of the artwork results may be based on definitions for specific color dominance, as well as interpretation of shapes and images within the artwork.

### BACKGROUND OF INVENTION

a. Field of Invention

The invention relates generally to methods of creating artwork.

b. Description of Related Art

The following patents are representative of a log in system:

U.S. Pat. No. 7,094,292 B2 to Randall et al. describes a mechanism and method for depositing oil paint, acrylics, or other textural paints and provides a means for automating the process of painting a picture. The process can be programmed into a database which is, stored and used at will, or the artist can utilize control means such as a joy stick to provide real-time input.

U.S. Pat. No. 6,676,311 B2 to Benger describes a method for creating a composite work of fine art that is the combination of two works of fine art. The creation of the first and second works of art that together form the composite work of fine art each include a hand-painting step. Preferably, for each of the first and second works of fine art, the hand-painting step follows the outputting of its corresponding image onto a substrate. Painting then occurs on top of the image substrate, which will speed the process and enhance its accuracy.

U.S. Pat. No. 6,168,438 B1 to Leonard et al. describes a method of creating vivid life-like paintings using a clear or translucent canvas that is provided. The method includes placing the canvas atop an image to be reproduced and tracing the outline and highlight colors from the image onto the front side of the canvas. The canvas is then turned over and field colors and background colors are applied to the backside of the canvas. As a final step, a clear coating can be applied to the front side of the canvas. The result is a surprisingly vivid and life-like rendering of the image when the-canvas is viewed from its front side. The rendering results from the combination of outlines and highlights on the front of the canvas and field and background colors visible through the canvas from the back side thereof, all enhanced by the clear coating.

U.S. Pat. No. 6,090,449 to Ferdinando et al. describes products that are disclosed to be applied to a given surface to be painted in which the drying time of the product on the coated surface is delayed so as to increase the useable working time for the painting surface. The base coating products consist generally of mixtures of synthetic resin water-based paints preferably acrylic colorless or colored paints, glycerin USP 96% and water in predetermined ratios by weight. The synthetic resin water-based paint as an ingredient when colorless provides a colorless base coating composition and, when colored, provides a colored base coating composition. The enumerated coating compositions may also include, in predetermined ratios, small quantities of surfactants and/or thickening agents which enhance the purpose and object of the enumerated coating compositions for delaying the drying time so as to increase the time during which the coated surface can be worked by applying, blending and overcoating the base coated surface with synthetic resin water base paints. Also illustrated is a method or process of “wet on wet” painting technique consisting of formulation the particular-base coating compositions desired, coating this particular base coating composition on at least one portion of the given painting surface and creating and overcoating the base coated painting surface by applying and working water-based paints so long as the base coated painting surface remains wet and workable. Additionally a painted surface with a base coating composition as the undercoating and an applied overcoating thereon consisting of synthetic resin acrylic paints. Additionally, an emollient to be mixed or stirred with a synthetic resin acrylic or water-based paint in relatively small quantities before using the paint, to delay the drying time thereof, has as its principal ingredient a humectant preferably glycerin USP 96%. These prior art paints are one type of paint that may be utilized in the present invention methodology.

### SUMMARY OF INVENTION

The term “primary colors” as used herein may be taken to mean both the lighting industry primary colors of red, green and blue, and the printing industry primary colors of cyan, yellow and magenta. Either set of primary colors may be used in the present invention process or both sets may be used.

The present invention solves the problems and overcomes the drawbacks and deficiencies of prior art methodology by providing intuitive techniques for creating artwork without the need for formal training or for high level painting skills. Further, the present invention methodology offers interesting interpretive techniques to help make the finished artwork more enriching and possibly insightful.

The present invention is an automatic intuitive painting methodology for creating personal art with meaning interpretation. The objectives of this methodology include offering people who are not considered artists or artistic, as well as others who are, the opportunity to create meaningful works of art. The methodology includes: (a) providing a user with a substrate and a plurality of separate paint supplies of different colors; (b) having said user identify said user's handwriting side and instructing said user to paint in accordance with the following instructions, only with the opposite limb from said handwriting side, as follows: (i) paint with no painting implement and use any one or more portions of said opposite limb including upper arm, elbow, forearm, wrist, hand, palm, knuckles and fingers; (ii) apply a plurality of said paints to said substrate by hand; (iii) create movement of wet paint on said substrate with movement of said one or more portions of said opposite limb; (iv) rotate said substrate at least once and create further movement of said paint with movement of said one or more portions of said opposite limb to produce a finished work of art; (c) applying interpretation to said finished work of art based on at least one set of definitions based on at least one criterion selected from the group consisting of color, shape, value, perceived form, symbolic cognition, and combinations thereof.

In some preferred embodiments of the present invention methodology, the creation of movement of wet paint further includes direct blowing on said wet paint with said user's breath.

In some preferred embodiments of the present invention methodology, the plurality of paint supplies of different colors includes at least white and the three primary colors.

In some preferred embodiments of the present invention methodology, the paint is applied by hand while the substrate is approximately horizontal and the paint movement is performed while the substrate is approximately upright.

In some preferred embodiments of the present invention methodology, the substrate is selected from the group consisting of a canvas substrate and a waterproof foamboard substrate.

In some preferred embodiments of the present invention methodology, the plurality of separate paint supplies is acrylic. However, any workable paint may be used, such as diluted oils, watercolors, latex, etc.

In some preferred embodiments of the present invention methodology, the user is required to create some movement of paint with the upper arm, some with the forearm and some with the elbow.

In some preferred embodiments of the present invention methodology, the set of definitions includes a color vocabulary with different colors corresponding to personal characteristics.

In some preferred embodiments of the present invention methodology, the color vocabulary includes color correlation to spiritual, mental, emotional and physical characteristics.

In some preferred embodiments of the present invention methodology, color vocabulary includes the following definitions and correlations: white—spiritual involvement; purple/violet—beliefs and ethics; cyan blue—mental acumen; light blue—expressiveness; green—spheres of choice; yellow—emotions and feelings; orange—ability to act; magenta—physical phenomena; red—passionate action; black and dark hues—challenges and unmanifested potential.

In some preferred embodiments, the color vocabulary is based on ancient Eastern chakra ‘energy center’ interpretation.

In some preferred embodiments, before the opposite limb is used for applying and moving paint, the opposite limb is coated with a protective barrier cream.

In another embodiment of the present invention, the automatic intuitive painting methodology for creating personal art with meaning interpretation, includes: (a) providing a user with a first substrate and a second substrate and a plurality of separate paint supplies of different colors; (b) having said user identify said user's handwriting side and instructing said user to paint on said first substrate in accordance with the following instructions, only with the opposite limb from said handwriting side, as follows: (i) paint with no painting implement and use any one or more portions of said opposite limb including-upper arm, elbow, forearm, wrist, hand, palm, knuckles and fingers; (ii) apply a plurality of said -paints to said first substrate by hand; (iii) create movement of wet paint on said first substrate with movement of said one or more portions of said opposite limb; (iv) rotate said first substrate at least once and create further movement of said paint with movement of said one or more portions of said opposite limb to produce a finished work of art; (c) having said user paint'said second substrate in accordance with the following instructions: (i) apply a plurality of said paints to said second substrate by hand while said second substrate is approximately horizontal; (ii) create movement of paint on said second substrate by tilting and rotating said second substrate in more than one plane; (iii) rest said second substrate in an approximately upright position to allow undried paint to flow, and optimally rotate same; (iv) return said second substrate to an approximately horizontal position and repeat steps (c) (ii) and (c) (iii) at least once, apply step (b) (iii) to at least some areas of bare substrate then return to an approximately horizontal position until dry to create a second finished work of art; (d) applying interpretation to said first and said second finished works of art based on at least one set of definitions based on at least one criterion selected from the group consisting of color, shape, value, perceived form, symbolic cognition, and combinations thereof.

In some preferred embodiments of this present invention methodology, the creation of movement of wet paint further includes direct blowing on said wet paint with said user's breath. In some preferred embodiments of this present invention methodology, the plurality of paint supplies of different colors includes at least white and the three primary colors. In some preferred embodiments of this present invention methodology, the paint is applied by hand while the substrate is approximately horizontal and the paint movement is performed while the substrate is approximately upright. In some preferred embodiments of this present invention methodology, the substrate is a canvas substrate or a waterproof foamboard substrate. In some preferred embodiments of this present invention methodology, the first and second finished works of art are placed together by a user to achieve a desired aesthetically acceptable connection and physically connecting them together to create a diptych. In some preferred embodiments of this present invention methodology, the user is required to create some movement of paint with the upper arm, some with the forearm and some with the elbow. In some preferred embodiments of this present invention methodology, the set of definitions includes a color vocabulary with different colors corresponding to personal characteristics. In some preferred embodiments of this present invention methodology, the color vocabulary includes color correlation to spiritual, mental, emotional and physical characteristics. In some preferred embodiments of this present invention methodology, the color vocabulary may include the following definitions and correlations: white—spiritual involvement; purple/violet—beliefs and ethics; cyan blue—mental acumen; light blue—expressiveness; green—spheres of choice; yellow—emotions and feelings; orange—ability to act; magenta—physical phenomena; red—passionate action; black and dark hues—challenges and unmanifested potential.

The color vocabulary may be based on ancient Eastern chakra, or ‘energy center’ interpretation.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a schematic flow diagram of one embodiment of the present invention methodology;

FIG. 2 is a second schematic flow diagram of another embodiment of the present invention methodology;

FIG. 3 is a third schematic flow diagram of another embodiment of the present invention methodology; and,

FIG. 4 is a fourth schematic flow diagram of another embodiment of the present invention methodology.

### DETAILED DESCRIPTION OF THE EMBODIMENTS

Referring now to the drawings, the various steps in the present invention methodology are set forth.

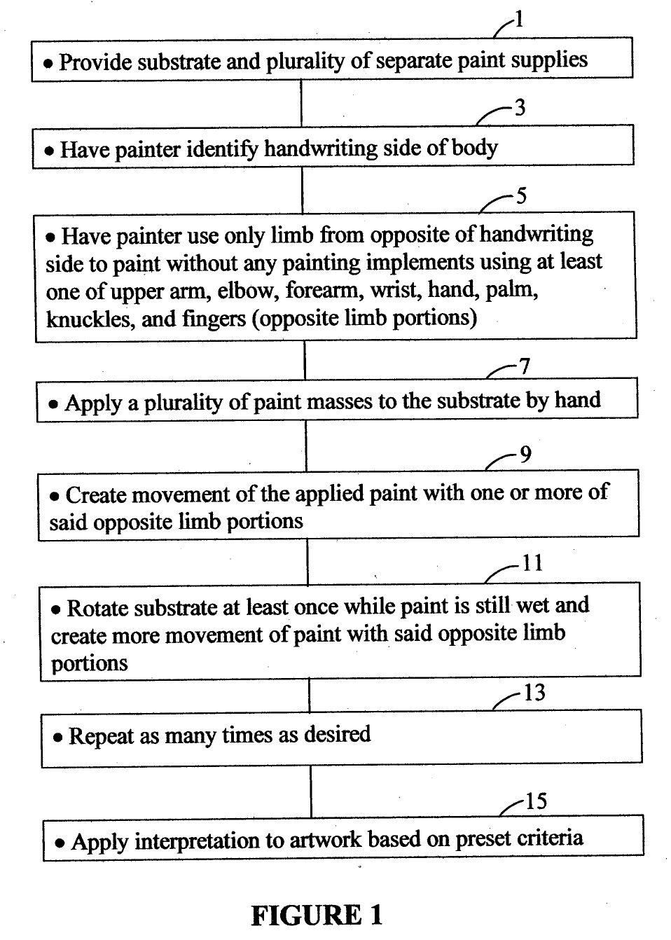

FIG. 1, block 1 shows to provide substrate and plurality of separate paint supplies. Block 3 illustrates to have painter identify handwriting side of body. Block 5 shows to have painter use only limb from opposite of handwriting side to paint without any painting implements using at least one of upper arm, elbow, forearm, wrist, hand, palm, knuckles, and fingers (opposite limb portions). Block 7 illustrates to apply a plurality of paint masses to the substrate by hand. Block 9 shows to create movement of the applied paint with one or more of said opposite limb portions. Block 11 illustrates to rotate substrate at least once while paint is still wet and create more movement of paint with said opposite limb portions. Block 13 shows to repeat as many times as desired. Block 15 illustrates to apply interpretation to artwork based on preset criteria.

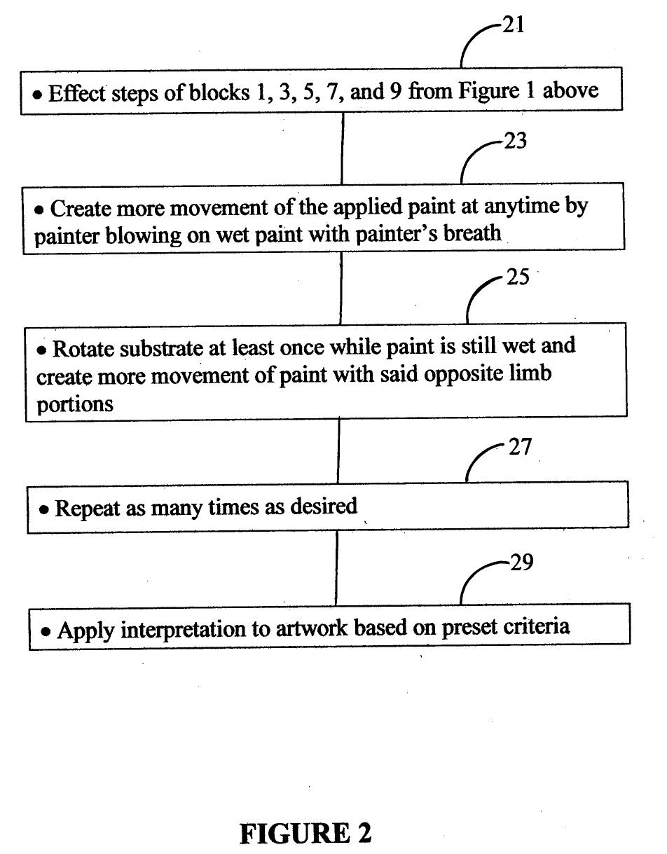

FIG. 2, block 21 shows to effect steps of blocks 1, 3, 5, 7, and 9 from FIG. 1 above. Block 23 illustrates to create more movement of the applied paint at anytime by painter blowing on wet paint with painter's breath. Block 25 shows to rotate substrate at least once while paint is still wet and create more movement of paint with said opposite limb portions. Block 27 illustrates to repeat as many times as desired. Block 29 shows to apply interpretation to artwork based on preset criteria.

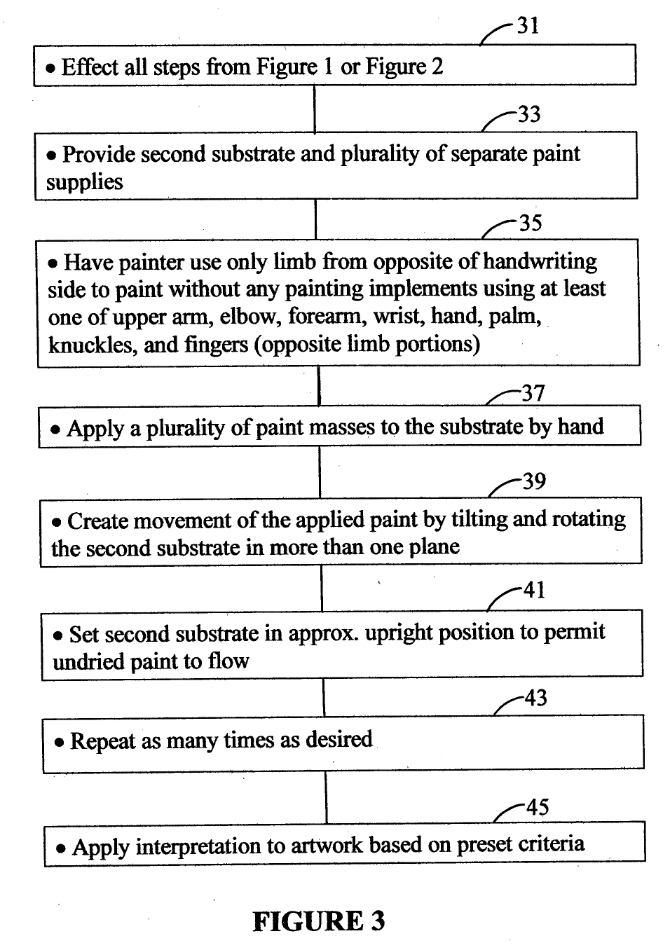

FIG. 3, block 31 shows to effect all steps from FIG. 1 and FIG. 2. Block 33 illustrates to provide second substrate and plurality of separate paint supplies. Block 35 shows to have painter use only limb from opposite of handwriting side to paint without any painting implements using at least one of upper arm, elbow, forearm, wrist, hand, palm, knuckles, and fingers (opposite limb portions). Block 37 illustrates to apply a plurality of paint masses to the substrate by hand. Block 39 shows to create movement of the applied paint by tilting and rotating the second substrate in more than one plane. Block 41 illustrates to set second substrate in approximately upright position to permit undried paint to flow. Block 43 shows to repeat as many times as desired. Block 45 illustrates to apply interpretation to artwork based on preset criteria.

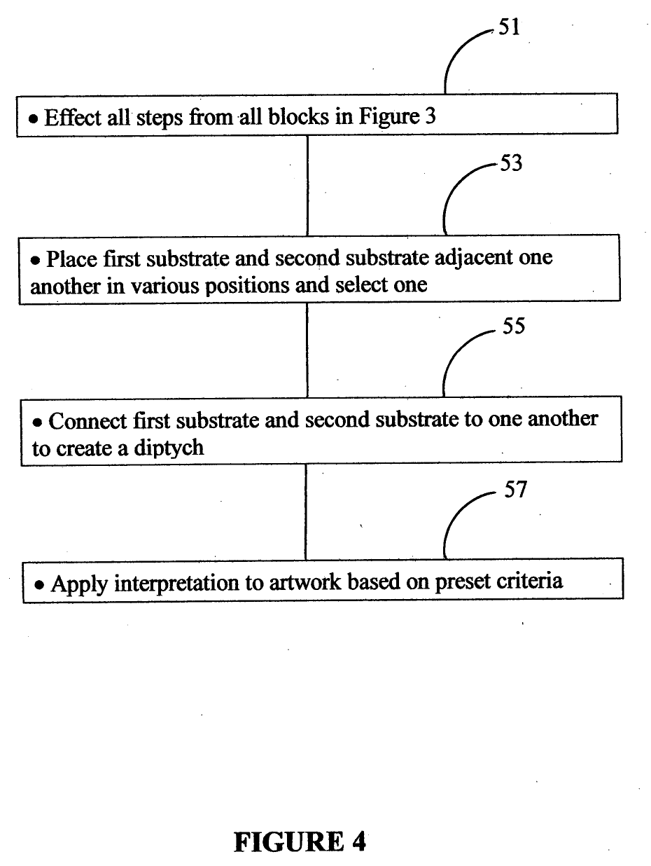

FIG. 4, block 51 shows to effect all steps from all blocks in FIG. 3. Block 53 illustrates place first substrate and second substrate adjacent one another in various positions and select one. Block 55 shows to connect first substrate and second substrate to one another to create a diptych. Block 57 illustrates to apply interpretation to artwork based on preset criteria.

The primary advantageous concepts of the present invention methodology are threefold:

1. That connection with one's source of unconscious information can be automatically established when paint is applied intuitively to canvas through the pure joy of painting.

2. That this joyful painting process (of automatically liberating unconscious information of value) becomes more easily intuitive by using no brushes and applying paint directly to canvas with the non-dominant hand, forearm, elbow, and knuckles. Painting in this method, one's intuitive connection is enhanced because the critical, analytical, calculating left-brain functioning is automatically sidestepped.

3. That there is an energetic language for color that can specifically decipher the unconscious information through addressing the painter's challenges and opportunities in terms of their physical appearance, their emotional functioning, their mental projections, and their spiritual connection.

The results of the present invention methodology are manifold:

1. The process yields a work of Dynamic Expressionism that has intrinsic aesthetic value in it's own right.

2. The educational value of the painting increases over time as the dynamically expressed information (automatically encoded in the art) emerges through symbolic means, changing the painting into a seemingly representational work of-art.

3. The painting has a certain therapeutic value in that emerging unconscious information has the ability to change the perception of the nature of one's life journey.

4. When painted in a series (as in a book format) the meaning of the multiple paintings delve deeply into a specific theme concerning the painter's life journey. This process illuminates the “Greater Thing Happening” and demonstrates the magnitude of one's spiritual connection.

5. When multiple paintings by different painters are connected together (as in a mural format) they show the collective dynamic of that group, and demonstrate how we all fit together in a beautiful and meaningful way.

Other personal growth results, dealing with the nature of creation in terms of meaning and purpose, of art and life, can be developed by focusing on different attributes of both the process and the product produced through the Paint Your Peace method.

Haiku or any other form of poetry or prose (deciphered form the artwork after it was painted) can be more easily comprehended when the following Color Vocabulary Key is applied to the colors in the artwork.

Based on pigment primaries CYM (Cyan, Yellow, Magenta) plus White and light primaries RGB (Red, Green, Blue) plus Black, the following meanings can be applied:

| CYM + W | RGB + K | MEANING |
|---|---|---|
| White | | Energies of the SPIRITUAL realm |
| | Blue/Purple | Energies of spheres of BELIEF |
| Cyan/light blue | | Energies of the MENTAL realm |
| | Green | Energies of spheres of CHOICE |
| Yellow | | Energies of the EMOTIONAL realm |
| | Red/orange | Energies of spheres of ACTION |
| Magenta/red | | Energies of the PHYSICAL realm |
| | Black | Energies of unmanifested POTENTIAL |

Interpretation of the resulting artworks is partially left to the imagination and viewpoint of the viewer, but the above table is also applied to communicate positive personality characteristics of and to the painter. Oftentimes faces, body profiles or silhouettes, animals, mythical characters, spiritual images, clouds, running water, fireballs and whirlpools may appear. Coupled with the above table, the images, may be interpreted of having meanings set forth above. This results in a much more meaningful and enriching experience for both the painter and subsequent viewers.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. An automatic intuitive painting methodology for creating personal art with meaning interpretation, which comprises:
(a) providing a user with a substrate and a plurality of separate paint supplies of different colors;
(b) having said user identify said user's handwriting side and instructing said user to paint in accordance with the following instructions, only with the opposite limb from said handwriting side, as follows:
(i) paint with no painting implement and use any one or more portions of said opposite limb including upper arm, elbow, forearm, wrist, hand, palm, knuckles and fingers;
(ii) apply a plurality of said paints to said substrate by hand;
(iii) create movement of wet paint on said substrate with movement of said one or more portions of said opposite limb;
(iv) rotate said substrate at least once and create further movement of said paint with movement of said one or more portions of said opposite limb to produce a finished work of art;
(c) applying interpretation to said finished work of art based on at least one set of definitions based on at least one criterion selected from the group consisting of color, shape, value, perceived form, symbolic cognition, and combinations thereof.

2. The automatic intuitive-painting methodology for creating personal art with meaning interpretation of claim 1 wherein said creation of movement of wet paint further includes direct blowing on said wet paint with said user's breath.

3. The automatic intuitive painting methodology for creating personal art with meaning interpretation of claim 1, wherein said plurality of paint supplies of different colors includes at least white and the three primary colors.

4. The automatic intuitive painting methodology for creating personal art with meaning interpretation of claim 1, wherein said paint is applied by hand while said substrate is approximately horizontal and said paint movement is performed while said substrate is approximately upright.

5. The automatic intuitive painting methodology for creating personal art with meaning interpretation of claim 1, wherein said substrate is selected from the group consisting of a canvas substrate and a waterproof foamboard substrate.

6. The automatic intuitive painting methodology for creating personal art with meaning interpretation of claim 1, wherein said plurality of separate paint supplies is acrylic.

7. The automatic intuitive painting methodology for creating personal art with meaning interpretation of claim 1, wherein said user is required to create some movement of paint with the upper arm, some with the forearm, and some with the elbow.

8. The automatic intuitive painting methodology for creating personal art with meaning interpretation of claim 1, wherein said set of definitions includes a color vocabulary with different colors corresponding to personal characteristics.

9. The automatic intuitive painting methodology for creating personal art with meaning interpretation of claim 8, wherein said color vocabulary includes color correlation to spiritual, mental, emotional and physical characteristics.

10. The automatic intuitive painting methodology for creating personal art with meaning interpretation of claim 9, wherein said color vocabulary includes the following definitions and correlations: white—spiritual involvement; purple/violet—beliefs and ethics; cyan blue—mental acumen; light blue—expressiveness; green—spheres of choice; yellow—emotions and feelings; orange—ability to act; magenta—physical phenomena; red—passionate action; black and dark hues—challenges and unmanifested potential.

11. The automatic intuitive painting methodology for creating personal art with meaning interpretation of claim 8, wherein said color vocabulary is based on ancient Eastern chakra ‘energy center’ interpretation.

12. The automatic intuitive painting methodology for creating personal art with meaning interpretation of claim 1 wherein, before said opposite limb is used for applying and moving paint, said opposite limb is coated with a protective barrier cream.

13. An automatic intuitive painting methodology for creating personal art with meaning interpretation, which comprises:
(a) providing a user with a first substrate and a second substrate and a plurality of separate paint supplies of different colors;
(b) having said user identify said user's handwriting side and instructing said user to paint on said first substrate in accordance with the following instructions, only with the opposite limb from said handwriting side, as follows:
(i) paint with no painting implement and use any one or more portions of said opposite limb including upper arm, elbow, forearm, wrist, hand, palm, knuckles and fingers;
(ii) apply a plurality of said paints to said first substrate by hand;
(iii) create movement of wet paint on said first substrate with movement of said one or more portions of said opposite limb;
(iv) rotate said first substrate at least once and create further movement of said paint with movement of said one or more portions of said opposite limb to produce a finished work of art;
(c) having said user paint said second substrate in accordance with the following instructions:
(i) apply a plurality of said paints to said second substrate by hand while said second substrate is approximately horizontal;.
(ii) create movement of paint on said second substrate by tilting and rotating said second substrate in more than-one plane;
(iii) rest said second substrate in an approximately upright position to allow undried paint to flow, and optimally rotate same;
(iv) return said second substrate to an approximately horizontal position and repeat steps (c) (ii) and (c) (iii) at least once, apply step (b) (iii) to at least some areas of bare substrate, then return to an approximately horizontal position until dry to create a second finished work of art;
(d) applying interpretation to said first and said second finished works of art based on at least one set of definitions based on at least one criterion selected from the group consisting of color, shape, value, perceived form, symbolic cognition, and combinations thereof.

14. The automatic intuitive painting methodology for creating personal art with meaning interpretation of claim 13 wherein said creation of movement of wet paint further includes direct blowing on said wet paint with said user's breath.

15. The automatic intuitive painting methodology for creating personal art with meaning interpretation of claim 13, wherein said plurality of paint supplies of different colors includes at least white and three primary colors.

16. The automatic intuitive painting methodology for creating personal art with meaning interpretation of claim 13, wherein said paint is applied by hand while said substrate is approximately horizontal and said paint movement is performed while said substrate is approximately upright.

17. The automatic intuitive painting methodology for creating personal art with meaning interpretation of claim 13, wherein said substrate is a canvas substrate or a waterproof foamboard substrate.

18. The automatic intuitive painting methodology for creating personal art with meaning interpretation of claim 13, wherein said first and second finished works of art are placed together by a user to achieve a desired aesthetically acceptable connection and physically connecting them together to create a diptych.

19. The automatic intuitive painting methodology for creating personal art with meaning interpretation of claim 13, wherein said user is required to create some movement of paint with the upper arm, some with the forearm and some with the elbow.

20. The automatic intuitive painting methodology for creating personal art with meaning interpretation of claim 13, wherein said set of definitions includes a color vocabulary with different colors corresponding to personal characteristics.

21. The automatic intuitive painting methodology for creating personal art with meaning interpretation of claim 20, wherein said color vocabulary includes color correlation to spiritual, mental, emotional and physical characteristics.

22. The automatic intuitive painting methodology for creating personal art with meaning interpretation of claim 21, wherein said color vocabulary includes the following definitions and correlations: white—spiritual involvement; purple/violet—beliefs and ethics; cyan blue—mental acumen; light blue—expressiveness; green—spheres of choice; yellow—emotions and feelings; orange—ability to act; magenta—physical phenomena; red—passionate action; black and dark hues—challenges and unmanifested potential.

23. The automatic intuitive painting methodology for creating personal art with meaning interpretation of claim 21, wherein said color vocabulary is based on ancient Eastern chakra, or ‘energy center’ interpretation.

24. The automatic intuitive painting methodology for creating personal art with meaning interpretation of claim 13 wherein, before said opposite limb is used for applying and moving paint, said opposite limb is coated with a protective barrier cream.
